(19) United States
(12) Patent Application Publication
(10) Pub. No.: US 2004/0247409 A1
(43) Pub. Date: Dec. 9, 2004

(54) Nut member with tightness-indicating protrusions

(76) Inventor: Chih-Chung Chiang, Tzu-Kuan Hsiang (TW)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/452,496

(22) Filed: Jun. 3, 2003

(51) Int. Cl. F16B 31/02

(52) U.S. Cl. 411/9

(57) ABSTRACT

A nut member includes a polygonal nut body having opposite first and second end faces, and a plurality of side faces extending between and interconnecting the first and second end faces. Each adjacent pair of the side faces cooperatively define a corner therebetween. A plurality of tightness-indicating protrusions are formed on and project axially and outwardly from the second end face of the nut body at positions adjacent to said corners, respectively.

### BACKGROUND OF THE INVENTION

1. Field of the Invention

The present invention relates to a nut member, more particularly to a nut member with tightness-indicating protrusions.

2. Description of the Related Art

Referring to FIGS. 1 and 2, a conventional fastening unit 1 includes a first nut 11 having an internal thread 112 that is disposed to engage an outer thread 210 of a bolt 21 for fastening two workpieces 22 together, and an outer thread 114. The fastening unit 1 further includes a second nut 12 having a first inner thread 122 engaging the outer thread 210 of the threaded bolt 21, and a second inner thread 121 engaging the outer thread 114 of the first nut 11.

The aforementioned first and second nuts 11, 12 are disadvantageous in that the extent of tightening of the first and second nuts 11, 12 cannot be observed, which may result in over-tightening of the first and second nuts 11, 12 and damage to the first and second nuts 11, 12.

### SUMMARY OF THE INVENTION

Therefore, the object of this invention is to provide a nut member with tightness-indicating protrusions, which is capable of overcoming the aforesaid disadvantages of the prior art.

According to the present invention, a nut member includes: a polygonal nut body defining an inner thread and having a first end face, a second end face opposite to the first end face, and a plurality of side faces extending between and interconnecting the first and second end faces, each adjacent pair of the side faces cooperatively defining a corner therebetween; and a plurality of tightness-indicating protrusions, each of which is formed on and projects axially and outwardly from the second end face of the nut body at a position adjacent to said adjacent pair of the side faces.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a fragmentary sectional view illustrating how a first nut of a conventional fastening unit engages a threaded bolt for fastening two workpieces together;

FIG. 2 is a fragmentary sectional view illustrating how first and second nuts of the conventional fastening unit engage the threaded bolt for fastening the workpieces together;

FIG. 3 is a perspective view of the preferred embodiment of a nut member according to the present invention;

FIG. 4 illustrates how the preferred embodiment cooperates with a threaded bolt to fasten two workpieces together in one way;

FIG. 5 illustrates how the preferred embodiment cooperates with the threaded bolt to fasten the workpieces together in another way;

FIG. 6 illustrates a state prior to tightening of two nut members of the present invention to fasten the workpieces together; and

FIG. 7 illustrates a state after tightening of the two nut members of the present invention to fasten the workpieces together.

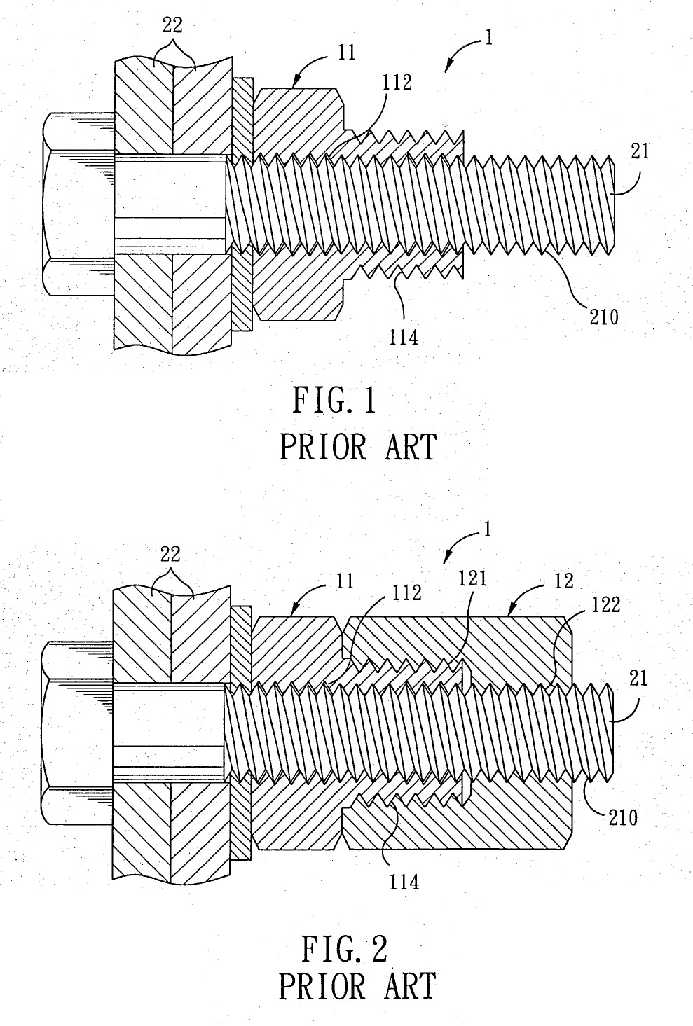

### DETAILED DESCRIPTION OF THE PREFERRED EMBODIMENT

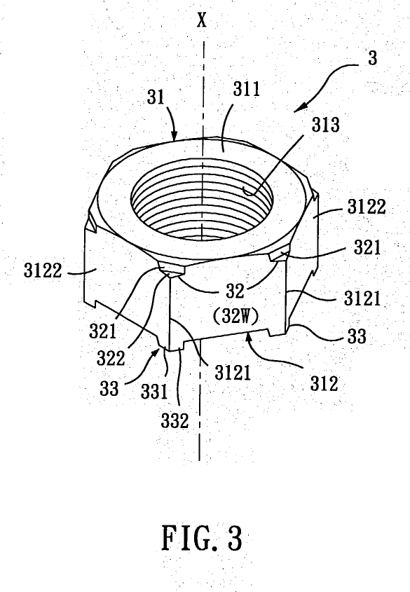

Referring to FIG. 3, the preferred embodiment of a nut member 3 according to the present invention is shown to include a polygonal nut body 31 and a plurality of tightness-indicating protrusions 33.

As illustrated, the polygonal nut body 31 defines an axis (X), and has an inner thread 313 surrounding the axis (X), a first end face 311, a second end face 312 opposite to the first end face 311, and a plurality of side faces 3122 that extend between and that interconnect the first and second end faces 311, 312. Each adjacent pair of the side faces 3122 cooperatively define a corner 3121 therebetween.

Each of the tightness-indicating protrusions 33 is formed on and projects axially and outwardly from the second end face 312 of the nut body 31 at a position adjacent to the corner 3121 of said adjacent pair of the side faces 3122. Each of the tightness-indicating protrusions 33 has first and second faces 331, 332 that are respectively flush with said adjacent pair of the side faces 3122.

In this embodiment, the first end face 311 of the nut body 31 is formed with a plurality of recesses 32 which are respectively disposed at the corners 3121, and which are respectively aligned with the tightness-indicating protrusions 33. Each of the recesses 32 is defined by a recess-defining wall 32W that has a rise wall face 321 which is parallel to the axis (X) and which is transverse to said adjacent pair of the side faces 3122, and a tread wall face 322 that is transverse to the rise wall face 321.

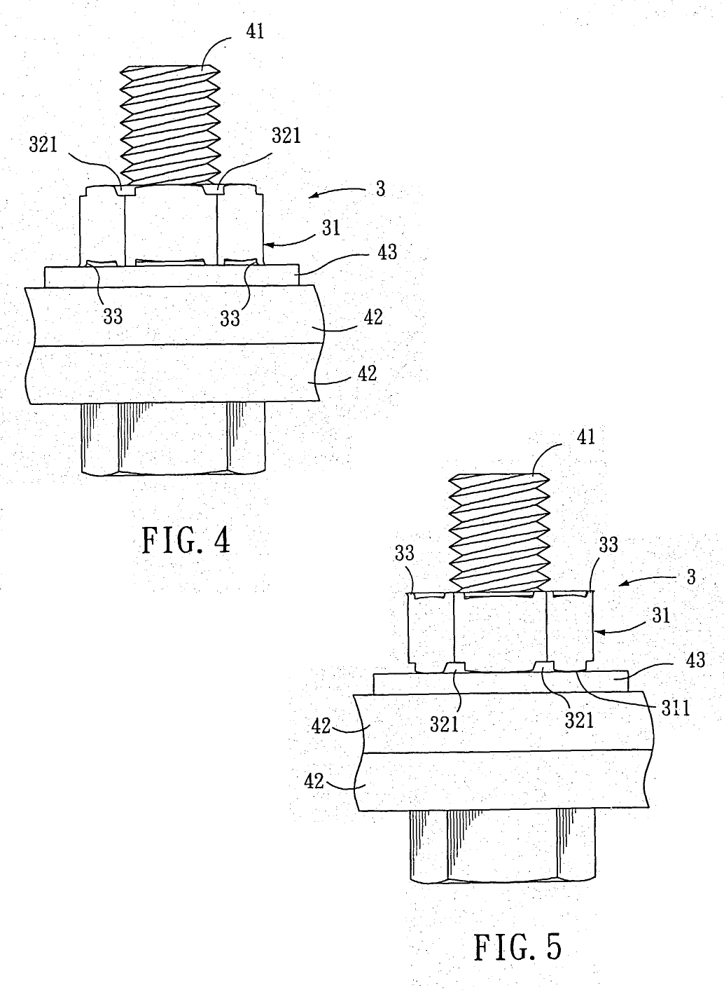

As shown in FIG. 4, when it is desired to fasten two workpieces 42 together, a threaded bolt 41 is inserted through the workpieces 42. A washer 43 is sleeved around the bolt 41 to abut against one of the workpieces 42. The nut member 3 is mounted threadedly on the threaded bolt 41, and is rotated by a tool (not shown) in such a manner that the tightness-indicating protrusions 33 of the nut member 3 abut against the washer 43. Tightening action of the nut member 3 relative to the threaded bolt 41 is conducted, and is stopped upon observing minor deformation of the tightness-indicating protrusions 33, which is an indication that the workpieces 42 have reached a fastened state.

Referring to FIG. 5, in case the nut member 3 is mounted on the threaded bolt 41 with the first end face 311 of the nut body 31 abutting against the washer 43, tightening of the nut member 3 with a tool (not shown) engaging the tightness-indicating protrusions 33 results in deformation of the tightness-indicating-protrusions 33, which is an indication that a fastened state of the workpieces 42 has been reached.

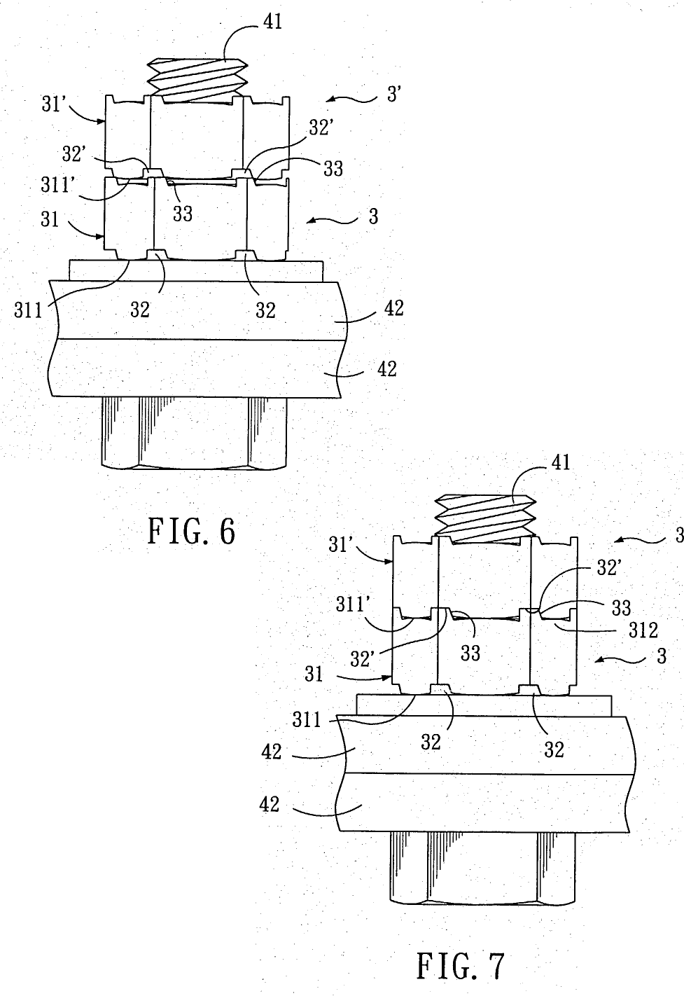

Two workpieces 42 can be fastened securely together by means of two nut members 3, 3′ of the present invention, as best shown in FIGS. 6 and 7, in which the first end faces 311, 311′ of the nut bodies 31, 31′ face the workpieces 42. FIG. 6 illustrates the nut members 3, 3′ at a loosened state. FIG. 7 illustrates the nut members 3, 3′ at a tightened state, in which each of the tightness-indicating protrusions 33 of the nut member 3 abuts against the tread wall face 322 (see FIG. 3) of a respective one of the recesses 32′ in the first end face 311′ of the nut body 31′ of the nut member 3′, and in which the second end face 312 of the nut body 31 abuts against the first end face 311′ of the nut body 31′.

The extent of deformation of the tightness-indicating protrusions 33 of the nut member 3 is related to the thickness thereof. The thickness of the tightness-indicating protrusions 33 of the nut member 3 can be varied so as to be adapted to fasten workpieces of different dimensions, which require different tightening forces.

With this invention thus explained, it is apparent that numerous modifications and variations can be made without departing from the scope and spirit of this invention. It is therefore intended that the invention be limited only as indicated in the appended claims.

I claim:

1. A nut member comprising:
a polygonal nut body defining an inner thread, and having a first end face, a second end face opposite to said first end face, and a plurality of side faces extending between and interconnecting said first and second end faces, each adjacent pair of said side faces cooperatively defining a corner therebetween; and
a plurality of tightness-indicating protrusions, each of which is formed on and projects axially and outwardly from said second end face of said nut body at a position adjacent to said corner of said adjacent pair of said side faces.

2. The nut member as defined in claim 1, wherein each of said tightness-indicating protrusions is formed on said second end face at a respective one of said corners, and has first and second faces that are respectively flush with said adjacent pair of said side faces.

3. The nut member as defined in claim 2, wherein said nut body defines an axis, said first end face of said nut body being formed with a plurality of recesses which are respectively disposed at said corners of said side faces, and which are respectively aligned with said tightness-indicating protrusions, each of said recesses being defined by a recess-defining wall that has a rise wall face which is parallel to said axis and which is transverse to said adjacent pair of said side faces, and a tread wall face that is transverse to said rise wall face.
